(19) United States
(12) Patent Application Publication
(10) Pub. No.: US 2004/0125988 A1
(43) Pub. Date: Jul. 1, 2004

(54) System and method for authenticating the source of marked objects

(75) Inventors: Frans M. Coetzee, Princeton, NJ (US); Christopher M. Colfer, London (GB); Andrew Barron, London (GB); Jeffrey R. Unger, Boston, MA (US); John T. Murphy JR., Highlands Ranch, CO (US); Gary R. Lerner, Lexington, MA (US)

Correspondence Address: Joel N. Bock, Sills Cummis Radin Tischman Epstein & Gross, P.A., One Riverfront Plaza, Newark, NJ, 07102, US

(73) Assignee: GenuOne, Inc, Boston, MA

(21) Appl. No.: 10/641,967

(22) Filed: Aug. 15, 2003

Related U.S. Application Data
(60) Provisional application No. 60/403,940, filed on Aug. 16, 2002.

(51) Int. Cl. G06K 9/00

(52) U.S. Cl. 382/112; 283/72

(57) ABSTRACT

An authentication system and method for identifying the source of a marking formed from marking media is disclosed. A registration system preferably tags batches of marking media with taggant material and, for each batch, stores physical property information representing one or more physical properties of that batch. A source assignment system receives source identification information for each of a plurality of sources, stores the source identification information in a database and, for each source, links the source identification information with at least one batch. A source identification system comprises at least one instrument operable to provide physical property information for the media in a marking. The identification system also includes an analysis system operable to compare the physical property information for the media in the marking with the physical property information associated with batches, and to then determine whether there one or more matches of physical property information exist.

### CROSS-REFERENCE TO RELATED APPLICATION

This application claims the benefit of priority under 35 U.S.C. §119(e) from U.S. Provisional Patent Application No. 60/403,940 filed Aug. 16, 2002 and entitled “Writing Instruments with Authentication Capability,” the contents of which are incorporated herein by reference.

### FIELD OF THE INVENTION

The present invention relates to the fields of authentication and counterfeit protection for marked objects. More particularly, it relates to a system and method for providing media for marking objects wherein the source of the markings can thereafter be verified and authenticated.

### BACKGROUND OF THE INVENTION

Globalization, the knowledge economy, and the proliferation of mass communications have increased the risk of counterfeiting, diversion and intellectual property theft. Counterfeiting is a deliberate attempt to deceive customers by unauthorized copying and marketing of items bearing known trade marks, indicators, or endorsements-often together with packaging and product configuration-and then attempting to pass these copies off as genuine or original articles. Diversion is the transfer or sale of products outside authorized channels that have been contractually agreed to. Such illegal actions erode brand value and undermine channel structures and price levels.

Faking documents and memorabilia of celebrities, sports stars, authors and politicians is an especially lucrative and growing problem. Different approaches that have been tried or suggested to combat this problem include: cataloging marked objects, e.g., by imaging the signed objects at the point of marking; creating only limited runs of products for specific marking events; creating and associating certificates of authenticity with each marked object; establishing an ownership registry to record first ownership of a marked object and any transfers thereof for provenance purposes; and/or creating and enforcing policies or contracts forbidding users from distributing marked objects outside approved venues or channels.

One such system and method for retrospective identification of articles, such as autographed memorabilia, is disclosed in U.S. Pat. No. 6,309,690 to Brogger et al. In this system, a unique mark is formed on the article, preferably using an adhesive or epoxic droplet containing microparticles. When the adhesive dries or cures, a pattern is formed by the shape, size, orientation, concentration, and spatial relationship of the microparticles. The unique mark formed by this pattern is then preferably imaged and stored in a database along with a description or identification of the article and information about the purchaser. In one embodiment, the signature is formed from ink having the microparticles entrained within it, and the signature itself forms the unique microcoded mark. Articles are also preferably stamped with a locator mark that helps locate the microcoded mark, and certificates of authenticity may also be used.

Unfortunately, such prior art authentication systems are often unduly complex for the party creating the marked object. More particularly, to maintain the legitimacy and effectiveness of the overall system, steps and procedures that are often undesirable, expensive and time-consuming are required, such as creating and cataloguing an image of a marking (and/or of a marked object) at the point of signature or creating a certificate of authenticity. There is consequently a need for a more efficient and cost-effective authentication solution that requires only minimal involvement from those creating or purchasing a marked object, while not compromising the ability to subsequently authenticate the source of markings on that object both efficiently and cost-effectively.

### SUMMARY OF THE INVENTION

The present invention relates to an authentication system and method using batches of marking media tagged with a unique (or relatively unique) set of one or more physical properties that can be systematically associated with a specific source, such as an individual or other entity. The marking media may be provided within a dedicated marking instrument, or marking media units may be provided separately and later installed in any suitable marking instrument. By linking a batch of marking media to a specific source, that source can unambiguously (or pseudo-unambiguously in some embodiments) mark objects as being authorized by it. The tagged marking media used to create such a marking can thereafter be associated, with a high degree of confidence, with the source or entity that produced the mark.

The system and method of the present invention overcome the shortcoming of other approaches, in that cataloging of the markings on objects is not necessary, and in that the markings may be applied at any time and in any place by a source. The uniquely characterized markings created using the marking media of the present invention relate to physical and objectively measurable properties of the marking media and not to how the media is applied or the shape of the marking produced. Thus, the system and method of the present invention does not require that any steps be carried out by an individual creating, purchasing or selling a marked object to preserve the ability to perform subsequent authentication.

Thus, in one aspect, the invention provides an authentication system for identifying the source of a marking formed from marking media. The system comprises a source assignment system operable to receive source identification information for each of a plurality of sources and to store the source identification information in an assignment database. For each source, the source assignment system links the source identification information with at least one of a plurality of marking media batches, each batch being further associated with a set of stored physical property information representing one or more physical properties of that batch. The system further comprises a source identification system including an analysis system and at least one instrument operable to provide physical property information for the media in the marking. The analysis system is operable to enable a comparison of the physical property information for the media in the marking with the physical property information associated with batches in the plurality of batches. The analysis system is further operable to thereafter enable a determination of whether the physical property information for the media in the marking matches the physical property information associated with one or more batches in the plurality of batches. The system preferably further comprises a registration system operable to store, in a registration database, the physical property information for each batch in the plurality of batches.

Similarly, in another aspect, the present invention provides a method of identifying the source of a marking formed from marking media. The method comprises receiving and storing source identification information for each of a plurality of sources. For each source, the source identification information is linked with at least one of a plurality of marking media batches, each batch being further associated with a set of stored physical property information representing one or more physical properties of that batch. During authentication, physical property information for the media in the marking is compared with the physical property information associated with batches in the plurality of batches, so that it can then be determined whether the physical property information for the media in the marking matches the physical property information associated with one or more batches. The method preferably also comprises identifying a source linked with the one or more batches associated with matching physical property information.

As a specific application, the present invention further provides a method of selling writing instruments and marking media to customers. In this method, writing instruments are offered for sale, the writing instruments being operable to mark objects using marking media. As a related service to the sale of writing instruments, batches of tagged marking media are also offered for sale, each batch exhibiting one or more physical properties. When a batch of tagged marking media is purchased by a customer, physical property information relating to the one or more physical properties of the batch is associated, in a database, with identification information for the customer. In this manner, the customer can be retrospectively identified based on a reading of at least one physical property in a marking formed from the tagged marking media purchased by that customer.

### BRIEF DESCRIPTION OF THE DRAWINGS

The objects and advantages of the present invention will be better understood and more readily apparent when considered in conjunction with the following detailed description and accompanying drawings which illustrate, by way of example, preferred embodiments of the invention and in which:

FIG. 1 is a block diagram of an authentication system for providing marking media and for enabling subsequent identification of the source of markings on objects marked using that media;

FIG. 2 is a block diagram showing one embodiment of marking media registration system in the authentication system of FIG. 1;

FIG. 3 is a block diagram showing one embodiment of marking media source assignment system in the authentication system of FIG. 1; and

FIG. 4 is a block diagram showing one embodiment of marking source identification system in the authentication system of FIG. 1.

### DETAILED DESCRIPTION OF PREFERRED EMBODIMENTS

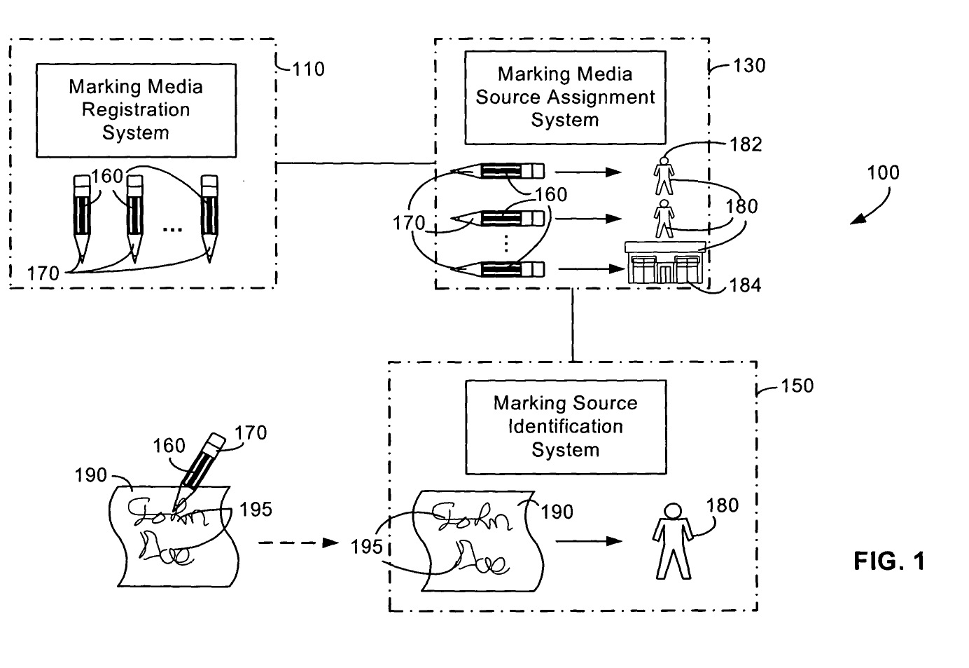

In accordance with a preferred embodiment of the present invention, FIG. 1 is a block diagram of an authentication system 100 for providing marking media and for enabling subsequent authentication of the source of markings made using that media. Authentication system 100 includes a marking media registration system 110, a marking media source assignment system 130, and a marking source identification system 150.

Referring to FIG. 1, registration system 110 is operable to register batches of marking media 160 by recording one or more uniquely identifiable physical properties associated with each marking media batch. In the illustrated embodiment, each batch of marking media 160 is contained within a corresponding marking instrument 170, as shown. If desired, one batch of marking media 160 may also correspond to the marking media in two or more marking instruments 170. In an alternative embodiment, system 110 may simply register batches of marking media 160 as separate units (i.e., independently from any particular writing instrument), and these marking media units may subsequently be used or installed in any suitable marking instrument (e.g., as refills). Marking media 160 and marking instruments 170 are preferably ink and pens respectively, however system 100 may also be used in conjunction with other types of marking media (e.g., toner, paint or stains) and with any type of marking instrument (e.g., stamps, printers, or photocopiers).

Source assignment system 130 is operable to assign and tag a batch of marking media 160—whether contained within or separate from one or more marking instruments 170—to a specific source 180. Source 180 is typically an individual 182 or an organizational entity 184 such as a corporation.

Marking source identification system 150 is operable to examine an object 190 having a marking 195 thereon and to then determine whether the marking corresponds to a source registered within source assignment system 130. More particularly, identification system 150 examines (e.g., scans or reads) marking 195 to determine whether the marking was made using marking media containing the one or more uniquely identifiable physical properties associated with a batch of marking media 160 registered within system 100. If a match is found, identification system 150 further determines whether a source has been associated with the registered batch of marking media 160, and, if so, can provide desired details about that source to a querying party. As illustrated in FIG. 1, marking 195 may be a signature formed upon object 190. Object 190 may in turn be a piece of paper, a document or an autographed memorabilia item such as a basketball.

Marking Media Taggants

In one preferred embodiment, authentication system 100 requires that each batch of marking media 160 have one or more unique properties to enable the batch to be unambiguously detected (in other embodiments described below, certain groups of batches may share the physical properties, in which case those properties may be described as “relatively unique”). Preferably, each batch of marking media 160 contains tagging material (i.e., taggants) inserted or introduced within it so that the tagged media batch thereafter exhibits the one or more desired unique physical properties.

As will be appreciated by those skilled in the art, a variety of techniques for introducing taggants into various substances for subsequent identification and authentication purposes are well known. For example, the following types of taggants may be added to batches of marking media 160: (i) combinations of chemical elements, such as the rare earth metals, that exhibit unique X-ray spectroscopy/fluoroscopy signatures and/or up-converting laser light properties (the rare earth elements include the elements Sc, Y, and the lanthanides La, Ce, Pr, Nd, Pm, Sm, Eu, Gd, Th, Dy, Ho, Er, Tm, Yb, Lu); (ii) unique combinations of multiple isotope ratios of one or more chemical elements, as described in U.S. Pat. No. 5,760,394, the contents of which are incorporated herein by reference; (iii) mixtures of organic and/or inorganic molecules that have a specific spectrographic absorption or emission spectrum and/or a specific photoluminescent decay signature; (iv) strands of DNA (deoxyribonucleic acid) whether generated artificially or extracted from natural organisms; (v) elements providing color-shifting ink where the pattern of wavelengths change based on illumination and/or orientation; (vi) elements introducing specific wavelength shifts under absorption/re-emission (i.e., Stokes shifts); (vii) micro-coded nano-particles produced using techniques common in semiconductor processing such as photolithography or molecular beam epitaxy (MBE) (e.g., Nanobarcodes™ particles, produced by Nanoplex Technologies, Inc. of Mountain View, Calif., which are encodeable, machine-readable, sub-micron sized taggants manufactured by electroplating inert metals- such as gold, nickel, platinum, or silver- into templates that define the particle diameter and then releasing the resulting striped nano-rods from the templates); or (viii) nano-particles that produce specific Raman scattering patterns. Advantageously, the physical properties produced by such taggants are, by themselves or in isolation, generally difficult and/or very expensive to reproduce without access to the production system and settings that were used to introduce the taggants within the marking media in the first place.

More generally, however, each batch of marking media 160 can be identified using any type of associated physical property, either alone or in combination. For example, taggants that occur naturally in certain types of marking media may be exploited for the purposes of the present invention. Furthermore, a layered identification approach may also be used whereby some physical properties of the media can be identified subjectively (such as an emitted color of light visible to the eye), and other properties can be more objectively or scientifically measured using an appropriate device or instrument. Importantly, the physical properties should also be detectable and measurable even when only small quantities of marking media 160 are present on an object, e.g., as would typically occur when marking media 160 is applied to an object using a pen or other writing instrument. The physical properties resulting from the tagging of a marking media batch should, in each case, also remain stable or predictable so that they do not change significantly or migrate in an unpredictable fashion over time (e.g., if the concentration of a taggant decays in a known and predictable manner, then the actual concentration can be predicted at any future time based on the initial concentration and the date of the creation of the tagged media).

Furthermore, the taggants used in marking media 160 should be capable of producing a relatively large number of distinct sets (or patterns) of physical properties each capable of being unambiguously distinguished from the others. For example, in one embodiment, each batch is tagged with a set of N elements selected from a known pre-screened pool of M elements, so that M!/(N!(M-N)!) different combinations of N elements can result. The elements may for instance be those in the Lanthanide series, i.e., rare earth metals. For instance, with N=8 and M=15, a total of 6435 unique combinations of elements that are generally not found in combination in nature are provided. Additionally, each of the N elements can be applied with a concentration at one of K levels (relative to a base concentration). This yields a total of approximately 6435*7^{k} unique patterns. For k=5, this yields 6435*16807 or more than 108 million taggant mixtures, where each mixture yields a X-ray fluoroscopy pattern (i.e., a set of physical properties) that can be reliably distinguished from that of every other mixture. Advantageously, with the above values of N, M and K, it is extremely difficult to determine the constituents and concentrations of the original mixture given only the X-ray pattern (a weak form of uniqueness guarantee). Furthermore, it is not possible to construct a different mixture of other constituents that will yield the same pattern (strong form of uniqueness guarantee), except by exhaustive construction of every single mixture and at prohibitive cost.

Marking Media Registration System

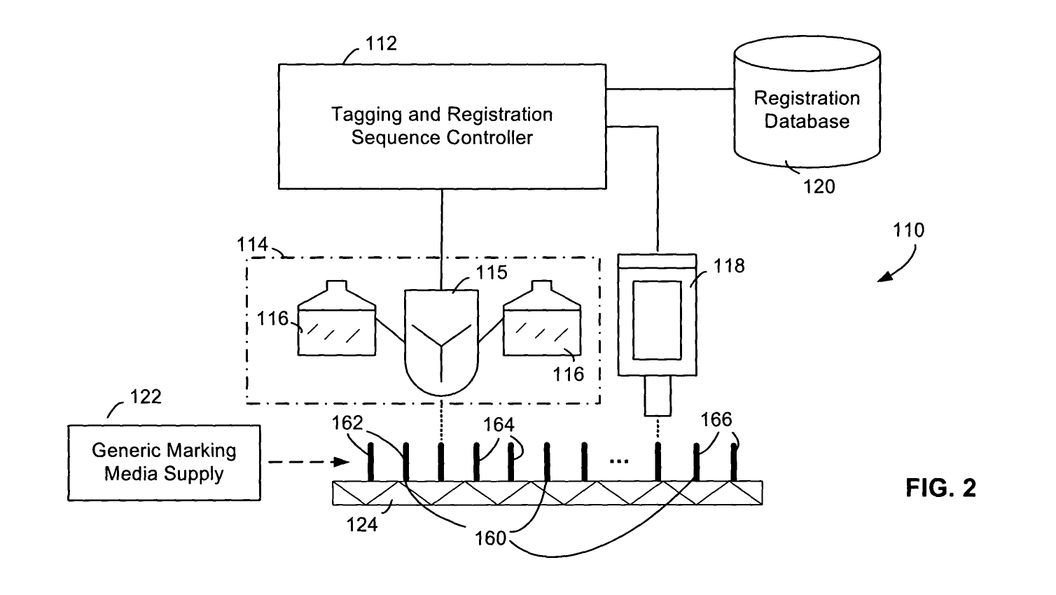

FIG. 2 is a block diagram showing a more detailed view of marking media registration system 110 in accordance with a preferred embodiment of the invention. In this embodiment, before recording and associating the one or more uniquely identifiable physical properties with a batch of marking media 160, registration system 110 first tags each batch with materials giving rise to those properties. In other embodiments, registration system 110 may alternatively operate separately from any system that tags each batch of marking media 160.

As shown in FIG. 2, registration system 110 comprises a tagging and registration controller 112, a taggant insertion module 114, a taggant read module 118, and a registration database 120. Controller 112 comprises a control system typically including computer hardware and software for coordinating both the tagging and registration of units (e.g., cartridges) of marking media 160 in desired batches. The marking media units 162, 164, and 166-shown at various stages along an exemplary conveyor system 124 during the tagging/registration process-include media from a generic (i.e., untagged) marking media supply 122. During this process, each marking media unit is preferably assigned with a product identifier such as a serial number or bar code identification label, and that identifier may be stamped on the units themselves or on packaging (not shown) that will later house a batch of one or more marking media units. Alternatively, the carrier for each marking media unit may have been previously assigned an identifier that is then provided to or read by controller 112. It will be appreciated that by locating registration system 110 inside a manufacturing or processing facility for the marking media, the tagging and registration of marking media batches can be conveniently carried out during the manufacture and/or packaging of the marking media units.

As shown in FIG. 2, taggant insertion module 114 comprises a taggant dispenser/mixer unit 115 and one or more sources 116 of taggant materials (only two shown). Dispenser/mixer 115 is preferably a computer controlled mixture injector such as those commonly used for mixing chemical and pharmaceutical products. Under the command of controller 112, taggant insertion module 114 injects specific amounts of one or more taggant materials (for e.g., rare earth elements) into untagged marking media units 162 to provide tagged marking media units 164. In an alternative embodiment, dispenser 115 may insert both generic marking media and the taggant materials into empty marking media containers. In this case, marking media supply 122 may simply be a tank of generic marking media that is connected to dispenser unit 115.

In the preferred embodiment of FIG. 2, taggant read module 1 18 comprises one or more instruments capable of examining the tagged marking media in units 164 and then determining or measuring the resulting set of unique physical properties of the tagged media. As will be appreciated, the type of measurement instruments and measurement techniques used will depend on the type of taggants used. For example, when marking media 160 is ink tagged with a particular rare earth element combination, the X-ray fluoroscopy (XRF) properties of the media may be obtained by X-raying a cartridge or unit containing the media using an X-ray fluorescent spectrometer. In this case, the unique physical properties will correspond to the resulting X-ray pattern. On the other hand, if the physical properties correspond to an absorption or emission spectrum of the tagged marking media within other wavelength bands, another type of spectrometer will generally be used. As another example, if Nanobarcodes™ particles are used to tag marking media 160, the resulting unique physical properties of the tagged media may be measured or identified using an optical microscope.

In one embodiment (not shown), taggant read module 118 examines the tagged marking media after it has been marked on an object's surface. For example, a writing sample of the tagged marking media may be generated on a piece paper using a robotic hand, the marking on the paper scanned, and the reference XRF pattern logged using a networked X-ray scanner in module 118. This approach may provide for a more reliable differentiation between tagged marking media batches whose physical properties do not differ significantly. Furthermore, such an approach may be desirable when the markings will eventually be applied to a particular type of surface (such as plastic), especially where the properties exhibited by the media on such a surface are difficult to predict.

Characterizing the physical properties of the tagged marking media using the above-described measurement-following-tagging approach may be preferred where there are physical limitations in the control of the tagging process or there is an inherent lack of a good model for predicting the final physical properties produced during the tagging process. However, if the unique physical properties of the tagged marking media are relatively stable and well-understood, those properties may also be predicted or calculated. For example, when producing and mixing Nanobarcodes™ particles to generate tagged marking media, the exact mixtures can be predicted and controlled by controller 1 12 using an appropriate sequencing routine during their dispensing. Thus, in another embodiment, when such predictable taggants are used, the physical properties associated with or exhibited by the marking media may simply be predicted or calculated by controller 1 12. As a result, in such an alternative embodiment, taggant read module 118 is not required in marking media registration system 110.

As a further alternative, the physical properties may first be predicted by controller 1 12 and then measured and calibrated using module 118. In this manner, quality control can be implemented by comparing the match between the predicted and measured sets of physical properties.

In another embodiment, a layered approach may be followed in the tagging of marking media 160, wherein various taggants with different physical properties having differing degrees of uniqueness are combined. For example, different combinations of rare earth elements may be used to tag each marking media unit in a batch so that each batch displays a unique X-ray fluoroscopy (XRF) response. In addition, the same up-converting crystals (i.e., phosphors that convert low energy infrared light into higher energy visible light) may be injected across several different batches with different XRF signatures. For example, for specific years, up-converting crystals that produce a given color frequency would be injected in all marking media units. In this manner, the up-converting marking media may be verified at more locations and with simpler and more cost-effective sensors than the X-ray fluoroscopic spectral sensors needed to examine or measure the XRF properties of a batch. Such a multi-stage authentication process is described further below. In such an embodiment, registration database may optionally associate the physical properties stemming from a taggant used across several batches with a single batch group (as opposed to separately associating those common group properties with each batch within the group).

Once the marking media units have been tagged and the physical properties stemming from that tagging are either read by taggant read module 118 or calculated/predicted by controller 112, a digitized representation of those properties, i.e., physical property information, is stored in registration database 120. More specifically, the physical property information of a marking media batch and any unique identifier assigned by or provided to controller 112 are stored together as registration information for that batch. The registration information may also include other batch related product information, such as its brand name, size, color, and the date and location of creation or tagging. The tagged and registered marking media batches can then be inventoried and indexed for retrieval, for example by an inventory management system (of which controller 112 may form a component). In this manner, the information in registration database 120 includes a record of each tagged marking media batch which includes its unique physical properties that can be used for marking source assignment purposes in the manner described below.

For high volume applications where there are a large number of batches with distinct physical property signatures, the performance of the database as well as the implementation of different access levels and security levels may be improved by suitable indexing of the physical property information. For example, once the physical property information has been digitized, a hash code or a pre- or postfix code may be calculated and associated with the relevant batch in system 110. Where a hash code is used, for instance, the physical property readings for a batch need not be disclosed to any personnel, and can in fact be destroyed after a hash code for each batch has been computed by controller 112 and stored as registration information in database 120. In this manner, the hatch code effectively becomes the physical property information for the batch in database 120. Hash codes for a marking 195 can then be similarly computed based on a measurement of media in marking 195 and then matched with one or more hatch codes in database 120. If desired, the registered batches can be numerically sorted by hatch code within database 120 to facilitate the subsequent searching for and identification of a match (e.g., using binary search techniques). Where pre-or postfix codes are used, different access levels may correspond to specific bits that can be accessed, allowing verification of the batch or group of batches to which a set of physical properties belongs by some personnel, with full access only allowed to others.

Although not preferred, in cases where storing the physical properties of a tagged marking media unit in digitized form is impractical, a physical sample of the tagged marking media can be kept and archived for later comparison. In this case, the registration information maintained in database 120 may include a record of the location of the archived sample to facilitate such a subsequent comparison.

Marking Media Source Assignment System

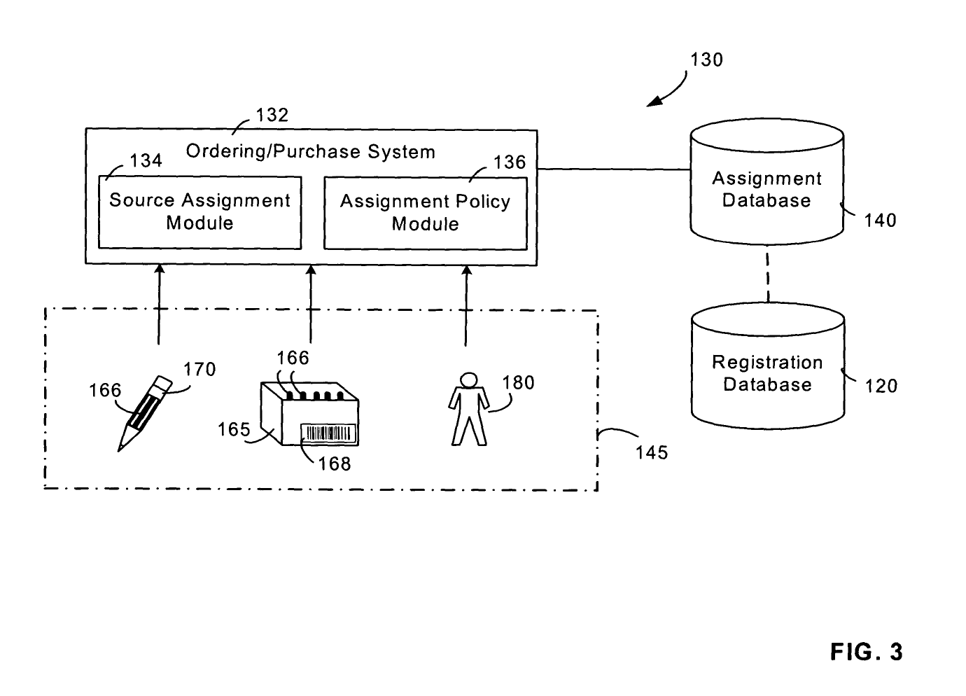

FIG. 3 is a block diagram showing a more detailed view of marking media source assignment system 130 in accordance with a preferred embodiment of the invention. As shown, system 130 comprises a computerized ordering/purchase system 132 and an assignment database 140. Ordering/purchase system 132 comprises hardware and software for handling the ordering and/or purchase, by a source 180, of batches of marking media registered in system 110. For example, and as shown, a source 180 may purchase a writing instrument 170 containing a single marking media unit 166, in which case that single marking media unit may correspond to a batch that is distributed with writing instrument 170. As another example, a source 180 may purchase a package 165 of several marking media refill units 166, in which case the entire package 165 may correspond to a batch.

As shown in FIG. 3, ordering/purchase system 132 preferably comprises a source assignment module 134 and an assignment policy module 136. Upon the fulfillment of an order or purchase, module 134 links or associates a registered batch of marking media 160 with a set of identification information for the source 180 and stores that information in assignment database 140. The source identification information may include the source's name, address, title/position, authorized personnel (if source 180 is a corporation or other group entity) and any other relevant information that may be desired for identification or security purposes. If the order or purchase is submitted electronically over a network, the source identification information may also be submitted in that manner; otherwise it may be gathered and entered by authorized authentication system personnel.

Generally, within database 140, assignment module 134 may associate the set of source identification information with all or part of the registration information for a batch. In one embodiment, assignment database 140 links the source identification information with only the product identifier for a registered batch of marking media 160. Authorized authentication system personnel may, for example, automatically obtain that product identifier by scanning a bar code label 168 associated with the registered batch. A source 180 can thereafter be further linked with the unique physical properties exhibited by the registered batch of marking media 160 via registration database 120. Alternatively, the source identification information may also be linked directly with the physical property information of the registered marking media batch, in which case assignment database 140 and registration database 120 may simply comprise a single merged database. However, maintaining separate databases is preferable for high security applications in which it is desirable to keep the contents of registration database 120 (in particular information regarding registered batches' physical properties) as secure as possible.

The source assignment carried out by system 130 may be provided as a premium or add-on service to the sale of tagged marking media 160 and marking instruments 170 containing such tagged marking media. For example, to provide such a service, an authorized clerk at a retail store environment 145 in which writing instruments 170 and registered batches of marking media 160 are sold may have access to ordering/purchase system 132 and assignment database 140 (i.e., by way of a computer network).

When assigning a batch of marking media to a source, assignment policy module 136 in system 132 may require that various assignment and security rules be adhered to, so that module 134 can only assign a batch to a particular source if certain policy conditions are met. Exemplary policy conditions that may be invoked by module 136 in different embodiments of the invention are now described.

In one preferred embodiment, only small batches of marking media 160 are produced, and each batch exhibits physical properties that are different from any other batch. For example, in this embodiment, each batch may correspond to a single marking media unit 166 contained within a specific writing instrument 170, so that the marking media from any such writing instrument is distinguishable from any other writing instrument. In this manner, a distinctly tagged batch would be associated with a source each time a new writing instrument or a new refill unit (i.e., a new batch of marking media) is ordered. This approach may be preferable for high security applications since if the marking media 160 and/or marking instrument 170 associated with a source 180 is compromised, a new batch of marking media can simply be assigned while the compromised batch can be flagged within registration database 120 (or assignment database 140) as described below.

In another embodiment, marking media with a specific tagging (i.e., marking media exhibiting a specific set of one or more unique physical properties) is assigned to one source for the life of that source or the duration of that source's license to use the system. As the marking media is consumed, new batches with the same physical properties may be produced. Alternatively, once a source's current batch has been consumed, previously produced batches may be retrieved from inventory stock for that source. Storing previously produced batches is preferred when secure application and storage facilities are used, since producing larger volumes of marking media with a specific tagging at one time is typically more cost-effective. Also, in this embodiment, once the source has expired or its license ends, the specific tagging is preferably retired from future use within system 100 (i.e., it is not re-used for new source entities).

While having distinctly tagged marking media for each particular source is preferred from the standpoint of overall system security and integrity, in the interests of cost efficiency and simplicity, system 130 may also assign similarly tagged marking media to different sources who have a low likelihood of marking objects of the same type. For example, celebrities may be grouped by field of endeavor, such as Nobel-prize winners and sports stars. (It will be appreciated that Nobel prize winners are not likely to autograph basketballs, and basketball stars are unlikely to sign first editions of laureate speeches.) In this way, the source of a marking can still be narrowed down to a small group of entities, and with high likelihood to a specific source within that group. Preferably, in this embodiment, no single source receives a batch tagged with the same physical properties more than once. This embodiment provides a trade-off in terms of advantages since it provides for the higher level of security associated with rotating the tagged marking media issued to a single source over time, while retaining the cost-effectiveness of producing marking media in larger batches.

In still another embodiment, a licensed source 180 of authentication system 100 is periodically provided with additional marking media in an effort to limit the amount of marking medium dispensed to that source at any one time. For example, batch refills of marking media 160 may be provided to owners of cartridge pens over the lifetime of the source. Such a replenishment policy may be desirable to improve security, maintain continuous quality over the marking media in use, and/or to limit production cost control.

Similarly, in a system using a layered tagging approach, different groups of multimedia batches may have been tagged with crystals that produce different color frequencies when up-converted. In such a system, policy module 134 may ensure that all marking media units issued in, for e.g., a certain year, exhibit a specific up-converting color.

It is also important to ensure the secure fulfillment of orders for replacement/refill batches of marking media, particularly for those orders that have been electronically submitted. When a first batch of marking media is purchased the source's identification information is initially registered as described above and may include security verification information, such as a date of birth, password or security verification questions. Any subsequent orders for replacement/refill batches of marking media are then verified against the information provided by the user. An authorized address or addresses for delivery of marking media may also be provided, where an authorized address can only be changed or added if further security clearance checks are met. Alternatively or in addition, purchases of replacement or refill marking media batches may use standard point of sale security—for example, requiring that a credit card belonging to the registered source be used and that the replacement marking media batch be delivered only to an address on file with the credit card company.

As an additional security policy condition, a registered source may be asked to certify that the original batch of the marking medium has been used before the delivery of a refill batch can be authorized. Where a cartridge or other type of carrier is used for the marking media, a replacement may also be delivered to the source only once a previously assigned carrier is returned. As a further option, the carrier itself (e.g., an ink refill or toner cartridge) may be uniquely marked with a suitable authentication element so that the carrier itself can be authenticated. In a similar manner, the carrier may be physically constructed or otherwise specifically designed so that it will only be possible to apply the registered marking media using a specific marking instrument. For example, an ink cartridge may be mechanically modified such as to be capable of mating (or being housed) only with a specific pen.

In specific cases, such as where a writing instrument is given to a celebrity, there may be a heightened risk that the writing instrument and its marking media are lost, stolen, or used without authorization. As a result, policy module 136 may also categorize or classify marking media batches to mitigate the risk associated with the loss of marking media 160 and/or marking instruments 170 containing that media. The classification of each batch is preferably stored as part of the registration information for that batch.

Thus, in one embodiment, all marking media batches provided by registration system 110 are initially categorized as “unissued” in registration database 120 and/or assignment database 140. Once a marking media batch is assigned by system 130, the batch is categorized as “in use” until consumption of the batch is reported by the registered source, at which time the batch is categorized in database 120 and/or 140 as “consumed.” If misuse of a batch in use is suspected, or if a batch in use is stolen, registered source 180 can report this and system 132 can then classify the batch as “compromised.” In this manner, markings 195 that have been attributed to a particular source 180 by source identification system 150 (as described below) can be considered to have different levels of confidence of authenticity, with the highest confidence being associated with items marked with batches marked as “consumed”, and decreasing confidence for states in order of: “in use,” “compromised” and “unissued.” If desired, additional data such as the type of compromise, its date, time and place, and the type of marked object being authenticated can be used to adjust the confidence level for a given authentication and/or to introduce more batch categories.

Marking Source Identification System

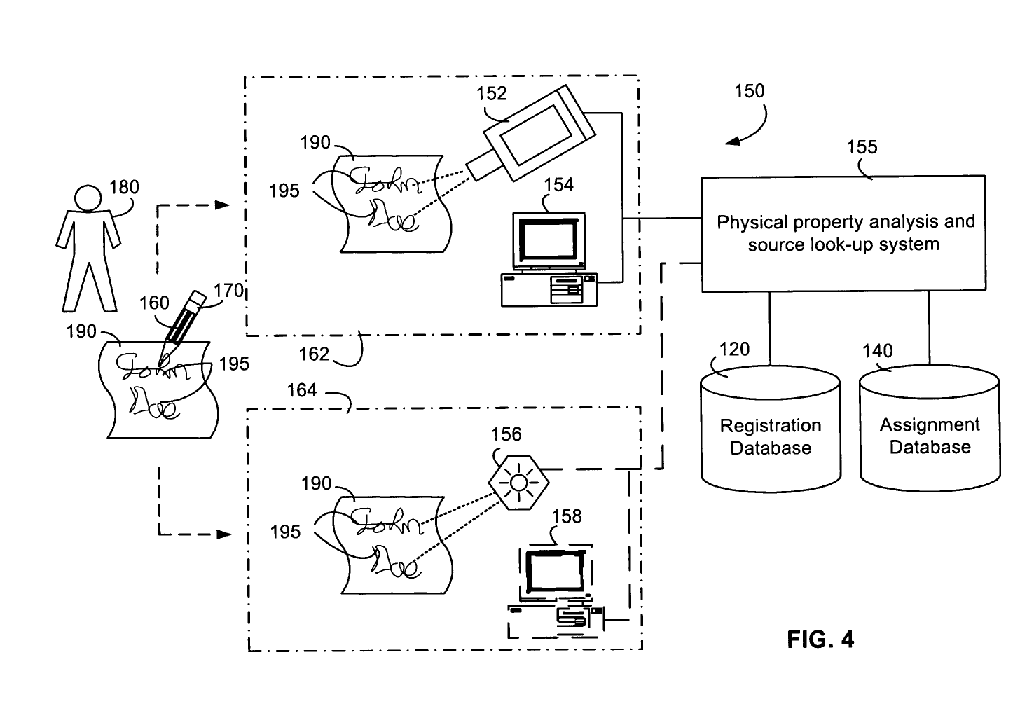

FIG. 4 is a block diagram showing a more detailed view of marking source identification system 150 in accordance with a preferred embodiment of the invention. As indicated, identification system 150 is used to examine an object 190 having a marking 195 thereon and to then determine whether the marking corresponds to a source registered within source assignment system 130.

In the illustrated embodiment, identification system 150 attempts to identify, i.e., authenticate, the source of marking 195 using a two phase approach. More particularly, identification system 150 comprises a physical property analysis and source look-up system 155 that is connected to both a main level authentication reader 152 and a coarse level authentication reader 156. System 155 is preferably a software application that has access to both registration database 120 and assignment database 140, as shown. To facilitate communication between an operator/user of the readers and system 155, authentication readers 152 and 156 may be connected to computer terminals 154 and 158 respectively.

Similar to taggant read module 118, each of readers 152 and 156 comprises one or more instruments (or sensors) capable of examining the media in marking 195 and measuring a desired type or set of physical properties in that marking. The specific measurement instruments and measurement techniques used will depend on the manner in which marking media 160 was tagged in registration system 110. In the illustrated embodiment, since a two phase approach to source authentication is being carried out, typically two types of taggants having different physical properties and differing degrees of uniqueness will have been previously used to tag marking media 160, however it will also be appreciated that a single type of taggant may be evaluated with two sensors of differing accuracy and/or precision. Coarse authentication reader 156 may be used to identify whether less unique taggants are present in the media of marking 195 and then, if necessary, main authentication reader 152 can be used to more discriminatingly identify whether taggants providing unique or batch-specific physical properties are present. In this manner, reader 152 may be located a central authentication facility 162, such as a manufacturing facility, while reader 156 may be located at a more widely-accessible authentication facility 164, such as in retail store environment. It will be appreciated that system 150 may comprise several authentication facilities 164, each with its own coarse level authentication reader 156. Similarly, there may be more than one authentication facility 162 with a main level authentication reader 152, however, it is expected that facilities 162 will generally number fewer and be less accessible than facilities 164.

In one specific example, a unique X-ray fluoroscopy signature was assigned to each marking media batch by system 110, while all the batches within a specific group were further injected with the same up-converting colored crystals (or the same up-converting colored crystals were injected across all batches). Coarse authentication reader 156 may then simply comprise a laser tuned to an exact frequency that will make the relevant up-converter crystal taggant fluoresce. Main authentication reader 152 may comprise a more intricate and expensive X-ray fluoroscopy sensor instrument for reading the X-ray fluoroscopy spectral response of the marking media. Reader 156 can then be used to carry out a coarse authentication by determining whether the media in marking 195 appropriately fluoresces (i.e., produces an appropriate color) when the laser light is incident upon it. In this instance, the operator of authentication reader 156 may be an authorized administrator of system 100 having confidential, a priori knowledge of how registered media in system 100 should fluoresce or, alternatively, this information may be provided to the operator by system 155 (and displayed on terminal 158). For example, system 155 can be polled to determine whether particular up-converting ink color has ever been issued to a purported source. As will be appreciated, if the coarse authentication is realized by an operator with such a priori knowledge who simply assesses whether the media appropriately fluoresces a certain color, terminal 158 and a connection to system 155 are not strictly necessary and can be dispensed with (hence these elements are shown in broken lines in FIG. 4). It will be appreciated that coarse-level authentication reader 156 may also comprise a more complex instrument (e.g., a desktop or portable XRF reader) that objectively measures a set of physical properties for the media in marking 195 and relays those readings to system 155 for further analysis and comparison.

If the media in marking 195 does not appropriately fluoresce, marking 195 was not created using a batch of marking media 160 of system 100 and therefore may be considered non-authentic (and possibly counterfeit). This allows for a more efficient, cost-effective, and widely-accessible first level verification with simpler and more cost-effective sensors than the X-ray fluoroscopic spectral equipment needed to perform main level authentication. Performing a coarse authentication in this manner therefore potentially allows for a large number of counterfeits to be ruled out inexpensively and at an early stage. On the other hand, if marking 195 does fluoresce appropriately when examined with reader 156, the marking may be further examined by main authentication reader 152 (e.g., by sending object 190 to facility 162). That subsequent authentication step, which is generally more discriminating or precise, determines whether the media in marking 195 corresponds to a registered batch of media 160 and, if so, who the source 180 associated with that batch is. (If, as described above, a group of sources had been assigned batches with the same set of physical properties, then each source in that group would be identified in this instance.)

Optionally, after a coarse level authentication, system 155 may return a group of possible sources 180 in database 140 who have been associated with marking media exhibiting the one or more physical properties exposed by reader 156. These may then be displayed to the user/operator on terminal 158 at facility 164. If the user or operator has an expectation concerning the identity of the source of marking 195, and that source is among those returned by system 155, this may provide authentication with a sufficient degree of confidence allowing the main level authentication phase to be skipped, if desired.

During the second or main phase of authentication, authentication reader 152 scans marking 195 to determine a set of relevant physical properties, digitizes that information and then sends this physical property information to system 155 for analysis and comparison. System 155 compares the physical property information resulting from the scan or reading of marking 195 with the corresponding physical property information for each batch registered in database 120. It will be appreciated that if the physical property information for marking 195 is limited (in terms of the actual physical properties to which it relates) compared to the physical property information for batches in database 120, then the physical property information for marking 195 is only compared to the relevant subset of physical property information for each batch in database 120.

As is well known to those skilled in the art, appropriate data coding, sorting and searching techniques may be used within system 100 to facilitate the comparison and matching of physical property information by system 155. Furthermore, depending on the nature of the physical properties, the degree of precision in digitizing representations of those properties, and other possible factors, an exact match in the physical property information may not be necessary and a small error or tolerance in the comparison may be permitted. If a match with a registered batch (or several registered batches) is found, then system 155 further determines whether a source 180 (or sources 180) has been assigned to that marking media batch (or batches) in database 140. As already indicated, databases 120 and 140 may comprise a single merged database. Via a display on terminal 154, system 155 then relays a relevant authentication response (e.g., details on the identity of the one or more matching sources 180 or that no authenticated source was found), to an operator or user at facility 162.

If desired, system 155 may restrict source authentication access to only certain querying parties and the decision to do so may vary from one source 180 to another. For example, a source 180 may specify that access to the source authentication data may be publicly available so that anyone is permitted to query system 150 to determine if that source was used to create a marking. Alternatively, express authorization (checked, for e.g., by a selected password) may be required to perform such queries. If authorization is required but has not been given, system 155 may return a “authentication access denied” response or the like. As a further option, system 100 may charge querying parties a fee for authentication, possibly paying a portion of the querying charge to the source as a further incentive for sources to purchase the marking media of system 100. For example, a sports team or league could purchase marking media 160 for all its members and have them sign all autographs with that media so that number of authentication queries over time may become quite significant. In this manner, the team or league could benefit financially from dealings of their autographs in the secondary market.

In another embodiment, auxiliary data can also be collected at the point of authentication, such as the name of the querying party and the date, time, place, object and use of the query. This auxiliary information can then be stored in an authentication database (not shown) and later reviewed to monitor use of system 150 and/or detect compromised use of the system.

Advantageously, with the authentication system of the present invention the cataloging of markings 195 on objects (e.g., using photography of an object and the actual marking each time an object is marked or autographed) is not necessary, nor are any other procedural steps such as creating a certificate of authenticity or recording details about what object was marked, when it was marked and where it was marked. A comprehensive trail to create a provenance does not have to be established, since origin and authenticity can be established unambiguously and objectively at a later date. Furthermore, markings 195 may also be applied to objects 190 at any time and in any place by a source 180 without jeopardizing the authentication process of system 100. The uniquely characterized markings 195 created using the marking media 160 of system 100 relate to physical and objectively measurable properties of the marking media and not to how the media is applied or the shape of the marking produced.

The authentication system of the present invention may be used in any field where the potential for counterfeit marked objects exists. However, it is particularly well-suited for applications in which counterfeit signatures are problematic such as: the autographing of memorabilia, limited or authorized issues of products, book signings, and limited editions of artwork and physical production products.

While the invention has been described in conjunction with specific embodiments, it is evident that numerous alternatives, modifications, and variations will be apparent to those skilled in the art in light of the foregoing description. In particular, it will be understood that many of the steps in the above-described authentication process can be performed either independently with different devices and/or in geographically distinct regions, or by merging or interchanging stages, as makes most commercial or technical sense. For example, the tagging of marking media may be physically carried out at the point of marking, such as may occur by mixing one or more vials in a pen during writing, with two or more tubes feeding a common writing tip. In this case, registration and calibration can be carried out in real-time using sensors within the pen that track the writing and feed the patterns (i.e., physical properties) and calibration data back to a computer via a wireless data link. Furthermore, the databases and communication networks mentioned above can comprise any commercially available system for maintaining and sharing data.

1. An authentication system for identifying the source of a marking formed from marking media, comprising:
a source assignment system operable to receive source identification information for each of a plurality of sources, to store the source identification information in an assignment database and, for each source, to link the source identification information with at least one of a plurality of marking media batches, each batch being further associated with a set of stored physical property information representing one or more physical properties of that batch; and
a source identification system comprising at least one instrument operable to provide physical property information for the media in the marking, and an analysis system operable to enable
a comparison of the physical property information for the media in the marking with the physical property information associated with batches in the plurality of batches and thereafter
a determination of whether the physical property information for the media in the marking matches the physical property information associated with one or more batches in the plurality of batches.

2. The system of claim 1 further comprising a registration system operable to store, in a registration database, the physical property information for each batch in the plurality of batches.

3. The system of claim 2 wherein, for each batch, the registration system is operable to store registration information in the registration database, wherein the registration information includes the physical property information associated with that batch and a product identifier associated with that batch.

4. The system of claim 2 wherein the assignment database and the registration database comprise a single database.

5. The system of claim 2 wherein the registration system further comprises a taggant insertion module operable to insert taggant materials into each batch in the plurality of batches to provide the one or more physical properties of that batch.

6. The system of claim 5 wherein the registration system further comprises a taggant read module operable to provide a reading of the one or more physical properties of each batch after that batch has had the taggant materials inserted therein, and wherein the physical property information associated with each batch is based, at least in part, on the reading for that batch.

7. The system of claim 5 wherein the physical property information associated with each batch is based, at least in part, on a prediction by the registration system.

8. The system of claim 5 wherein, for each batch, the taggant materials inserted into the batch comprise a specific combination of rare earth elements.

9. The system of claim 5 wherein at least a first type of taggant materials and a second type of taggant materials are inserted into each batch and wherein the source identification system comprises a first instrument operable to provide physical property information relating to physical properties generally arising due to the insertion of the first type of taggant materials, and a second instrument operable to provide physical property information relating to physical properties generally arising due to the insertion of the second type of taggant materials.

10. The system of claim 1 wherein the marking media is ink and at least some of the media batches are each contained within a corresponding writing instrument.

11. The system of claim 10 wherein each batch of ink is contained within one or more units, and the units for at least some of the batches are each specifically designed to mate only with the corresponding writing instrument.

12. The system of claim 1 wherein the physical property information for any batch linked to a particular source is unique compared to the physical property information for any batch linked to another source, and wherein, after determining that the physical property information for the media in the marking matches the physical property information associated with a batch, the source identification system further identifies the particular source linked with that batch.

13. The system of claim 1 wherein the physical property information for different batches linked to different sources are, in part, the same, and wherein, after determining that the physical property information for the media in the marking matches the physical property information associated with batches linked to two or more sources, the source identification system further identifies each of the two or more sources linked with those batches.

14. A method of identifying the source of a marking formed from marking media, comprising:
receiving and storing source identification information for each of a plurality of sources;
for each source, linking the source identification information with at least one of a plurality of marking media batches, each batch being further associated with a set of stored physical property information representing one or more physical properties of that batch;
comparing physical property information for the media in the marking with the physical property information associated with batches in the plurality of batches; and
determining whether the physical property information for the media in the marking matches the physical property information associated with one or more batches.

15. The method of claim 14 further comprising identifying a source linked with the one or more batches associated with matching physical property information.

16. The method of claim 15 wherein the physical property information for any batch linked to a particular source is unique compared to the physical property information for any batch linked to another source, and wherein after determining that the physical property information for the media in the marking matches the physical property information associated with a batch, the method comprises identifying the particular source linked with that batch.

17. The method of claim 15 wherein the physical property information for different batches linked to different sources are, in part, the same, and wherein, after determining that the physical property information for the media in the marking matches the physical property information associated with batches linked to two or more sources, the method further comprises identifying each of the two or more sources linked with those batches.

18. The method of claim 15 further comprising assigning to each batch a classification based on the last known state of that batch and, when a source is identified, providing the classification information assigned to the matching batch for that source to provide an indication of a confidence level for the identification.

19. The method of claim 14 further comprising storing the physical property information for each batch in the plurality of batches.

20. The method of claim 14 further comprising providing each source with at least one batch of marking media that has been linked with that source's identification information.

21. The method of claim 14 further comprising inserting taggant materials into each batch in the plurality of batches to provide the one or more physical properties of that batch.

22. The method of claim 21 further comprising reading the one or more physical properties of each batch after that batch has had the taggant materials inserted therein, wherein the physical property information associated with each batch is based, at least in part, on the reading for that batch.

23. The system of claim 21 further comprising predicting the one or more physical properties associated with each batch after that batch has had the taggant materials inserted therein.

24. The method of claim 14 comprising:
comparing a first set of physical property information for the media in the marking with the physical property information associated with batches in the plurality of batches;
identifying whether a plurality of sources linked with batches associated with physical property information match the first set of physical property information for the media in the marking;
if so, comparing a second set of physical property information for the media in the marking with the physical property information associated with batches in the plurality of batches; and
identifying a source linked with a batch associated with physical property information that matches the second set of physical property information for the media in the marking, wherein the second set of physical property information for the media in the marking enables a more discriminating comparison than the first set of physical property information for the media in the marking.

25. A method of selling writing instruments and marking media to customers comprising:
offering writing instruments for sale, the writing instruments being operable to mark objects using marking media;
as a related service to the sale of writing instruments, offering for sale batches of tagged marking media, each batch exhibiting one or more physical properties; and
when a batch of tagged marking media is purchased by a customer, associating, in a database, physical property information relating to the one or more physical properties of the batch with identification information for the customer to enable retrospective identification of the customer based on an reading of at least one physical property in a marking formed from the tagged marking media.

26. The method of claim 25 wherein a batch of tagged marking media comprises a unit contained within a corresponding writing instrument.

27. For use in an authentication system, a batch of tagged marking media that enables retrospective identification of a customer associated with the batch based on a reading of at least one physical property in a marking formed from the tagged marking media, the tagged marking media comprising:
a first taggant material exhibiting one or more physical properties capable of being read when the marking is examined using a first type of instrument in the authentication system; and
a second taggant material exhibiting one or more other physical properties capable of being read when the marking is examined using a second type of instrument in the authentication system.
